(19) United States
(12) Patent Application Publication
(10) Pub. No.: US 2009/0046556 A1
(43) Pub. Date: Feb. 19, 2009

(54) BIT DETECTION FOR OPTICAL DISC READING

(75) Inventor: Ruud Vlutters, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/278,985

(22) PCT Filed: Jan. 26, 2007
(86) PCT No.: PCT/IB2007/050271

§ 371 Date: Aug. 11, 2008

(30) Foreign Application Priority Data
Feb. 14, 2006 (EP) 06101625.9

(51) Int. Cl. G11B 20/18

(52) U.S. Cl. 369/53.35; G9B/20.046

(57) ABSTRACT

A bit detector (203) for an optical disc reading apparatus comprises an interface (401) which receives central aperture signal values from an optical disc reader (101). The interface is coupled to a threshold detector (403) which assigns a first data value to data bits having corresponding central aperture signal values above a first threshold and a second data value to data bits having corresponding central aperture signal values below a second threshold. The thresholds are set to provide high reliability of the assigned data values and to restrict the data resulting in central aperture signal values between the thresholds to minimum run length sequences. A run length detector (405) assigns data values to at least one data bit of a sequence of data bits having corresponding central aperture signal values between the first and second threshold in response to a run length coding of the data bits and a data value of at least one data bit adjacent to the sequence. Specifically, minimum run length sequences are determined based on the surrounding data.

### FIELD OF THE INVENTION

The invention relates to bit detection for optical disc reading and in particular, but not exclusively, to low complexity bit detection in an optical storage disc reading system.

### BACKGROUND OF THE INVENTION

Optical disc storage has proved to be an efficient, practical and reliable method of storing and distributing data such as evidenced by the popularity of storage disc formats such as Compact Discs (CDs) and Digital Versatile Discs (DVDs).

Methods and techniques for detecting and correcting bit errors in optical disc reading systems are known.

A particularly efficient technique for detecting correct bit values in the presence of bit errors is known as Maximum Likelihood Sequence Estimation and specifically Partial Response Maximum Likelihood (PRML) bit detection. In particular, the Viterbi algorithm is commonly used for communication systems and data extraction from storage media, such as optical discs, in the presence of media and electronics noise.

Viterbi based bit detection is frequently used in high-end modern optical disc systems in order to achieve reliable extraction of data stored on the optical disc. Furthermore, Viterbi bit detection is expected to play a major role for future generations of optical storage. In particular, the use of Viterbi detection allows an increment of the capacity of a Blu-ray™ Disc system from 25 GB to 35 GB per recording layer on a 12 cm disc.

However, such an increase in data capacity is achieved by a scaling the channel bit length down to 62 nm which makes bit detection increasingly difficult due to increased inter-symbol interference.

Detection at such a density with a Viterbi Detector is still feasible but such detectors have a significant disadvantage in having a large latency or processing delay.

Specifically, because Viterbi detectors have a large delay between in- and output, they cannot be used for many purposes and in particular they are unsuitable for data-aided feedback loops. However, data aided feedback loops are frequently used in bit detectors and are used in reference level units which determine reference levels used by the Viterbi detector. For this reason low complex threshold (slicer) detectors are typically used in such feedback loops and for providing data aided input to the reference level units.

However, a problem is that for increasing data capacity and reduced channel length, the inter-symbol interference is increased such that bit detection becomes increasingly difficult and specifically the decision point aperture eye may close for a number of bit combinations. For example, for a 30 GB Blu-ray™ disc reader a threshold detector has a bit error rate of around 0.1 which results in significantly degraded performance. Specifically, the reference levels for the Viterbi detector may become inaccurate or incorrect resulting in the Viterbi detection not being able to provide acceptable performance.

Hence, improved bit detection would be advantageous and in particular bit detection allowing reduced complexity, reduced error rate, reduced delay and/or increased performance would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided a bit detector for an optical disc reading apparatus, the bit detector comprising: means for receiving central aperture signal values from an optical disc reader; first means for assigning a first data value to data bits having corresponding central aperture signal values above a first threshold and a second data value to data bits having corresponding central aperture signal values below a second threshold; second means for assigning data values to at least one data bit of a sequence of data bits having corresponding central aperture signal values between the first and second threshold in response to a run length coding of the data bits and a data value of at least one data bit adjacent to the sequence.

The invention may allow a bit detector with improved performance. Specifically, a bit detector may provide reduced error rate, reduced latency and/or reduced complexity. The bit detector may be suitable for high capacity optical disc reading systems and may allow detection of data bits by low complexity processing despite high inter-symbol interference levels.

The invention may use knowledge of run length coding and highly reliable data decisions to determine data values for uncertain central aperture signal values.

According to an optional feature of the invention, the second means is arranged to divide the sequence into a number of subsets of a minimum run length and a remainder subset comprising a number of remaining data bits, the data bits in each subset being assigned the same data value and consecutive subsets in the sequence being assigned opposite data values.

The feature may improve bit detection and may in particular allow low complexity, low delay and low error rate detection of data bits in the presence of substantial inter-symbol interference.

The minimum run length may be a fixed, static minimum run length and/or may be variable and determined in response to a given function or algorithm resulting in varying sizes of the subsets. Each subset may specifically correspond to a minimum run length sequence and the remainder subset may correspond to the number of data bits left after division into the minimum run length sequences. The remainder subset may be empty. Specifically, the subsets may reflect the only possible options for data values of the data bits in the sequence which can result in central aperture signal values between the first and second threshold.

According to an optional feature of the invention, the second means is arranged to determine a first distance indication from a first central aperture signal value of an earliest data bit of the sequence to a threshold of the first and second threshold closest to a central aperture signal value of a preceding data bit preceding the earliest data bit; determine a second distance indication from a second central aperture signal value of a latest data bit of the sequence to a threshold of the first and second threshold closest to a central aperture signal value of a data bit following the latest data bit; and determining a location of the remainder subset at the beginning or end of the sequence in response to a comparison of the first and second distance indication.

The feature may improve bit detection and may in particular allow low complexity, low delay and low error rate detection of data bits in the presence of substantial inter-symbol interference. In particular, it may allow a low complexity decision criterion for data values reflecting constraints imposed by the run length coding and inter-symbol interference characteristics.

According to an optional feature of the invention, the second means is arranged to assign a data value to the remainder subset corresponding to a data value assigned to an adjacent data bit outside the sequence.

The feature may improve bit detection and may in particular allow low complexity, low delay and low error rate detection of data bits in the presence of substantial inter-symbol interference. Specifically, if the remainder subset is located at the start of the sequence, the data value may be set equal to the data bit immediately preceding the sequence thereby completing the run length sequence started outside the sequence interval. Similarly, if the remainder subset is located at the end of the sequence, the data value may be set equal to the data bit immediately following the sequence thereby completing the run length sequence which completes outside the sequence interval.

According to an optional feature of the invention, the second means is arranged to set a data value of an initial subset of the sequence to an opposite data value of a prior data value of a data bit immediately preceding the sequence if: the remainder subset is empty; the prior data value is different than a data value of a data bit immediately following the sequence; and a number of subsets in the sequence is even.

The feature may improve bit detection and may in particular allow low complexity, low delay and low error rate detection of data bits in the presence of substantial inter-symbol interference.

According to an optional feature of the invention, the second means is arranged to set a data value of an initial subset of the sequence to an opposite data value of a prior data value of a data bit immediately preceding the sequence if: the remainder subset is empty; the prior data value is identical to a data value of a data bit immediately following the sequence; and a number of subsets in the sequence is odd.

The feature may improve bit detection and may in particular allow low complexity, low delay and low error rate detection of data bits in the presence of substantial inter-symbol interference.

According to an optional feature of the invention, the second means is arranged to divide a subset into an initial subset located at a beginning of the sequence and a final subset at the end of the sequence and to assign a same data value to the initial subset as a prior data value of a data bit immediately preceding the sequence and a same data value to the final subset as a following data value of a data bit immediately following the sequence if: the remainder subset is empty; the prior data value is different than a data value of a data bit immediately following the sequence; and a number of subsets in the sequence is odd.

The feature may improve bit detection and may in particular allow low complexity, low delay and low error rate detection of data bits in the presence of substantial inter-symbol interference.

According to an optional feature of the invention, the second means is arranged to divide a subset into an initial subset located at a beginning of the sequence and a final subset at the end of the sequence and to assign a same data value to the initial subset as a prior data value of a data bit immediately preceding the sequence and a same data value to the final subset as a following data value of a data bit immediately following the sequence if: the remainder subset is empty; the prior data value is identical to a data value of a data bit immediately following the sequence; and a number of subsets in the sequence is even.

The feature may improve bit detection and may in particular allow low complexity, low delay and low error rate detection of data bits in the presence of substantial inter-symbol interference.

According to an optional feature of the invention, the first threshold and the second threshold are such that a probability of assigning an incorrect data value is below a threshold.

The feature may improve bit detection and may in particular allow low complexity, low delay and low error rate detection of data bits in the presence of substantial inter-symbol interference. The feature may specifically allow a reliable detection of data values outside a sequence to be used to determine a reliable detection of data values within a sequence with low threshold detection possibility. The threshold may for example be below 10⁻³.

According to an optional feature of the invention, the first threshold and the second threshold are such that a run length higher than a minimum run length of the run length code does not correspond to a central aperture signal value between the second and first thresholds.

The feature may improve bit detection and may in particular allow low complexity, low delay and low error rate detection of data bits in the presence of substantial inter-symbol interference. This may specifically allow accurate detection of data bits outside an uncertain sequence while restricting the possibilities of data within the sequence such that an accurate determination based on run length coding and data decision outside the sequence is practical.

According to another aspect of the invention, there is provided an optical disc reading apparatus comprising: a disc reader for generating a first signal by reading an optical disc; and a bit detector for an optical disc reading apparatus, the bit detector comprising means for receiving central aperture signal values from an optical disc reader; first means for assigning a first data value to data bits having corresponding central aperture signal values above a first threshold and a second data value to data bits having corresponding central aperture signal values below a second threshold; second means for assigning data values to at least one data bit of a sequence of data values having corresponding central aperture signal values between the first and second threshold in response to a run length coding of the data bits and a data value of at least one data bit adjacent to the sequence.

According to an optional feature of the invention, the optical disc reading apparatus further comprises: a reference level unit arranged to determine the first threshold in response to bit detections by the bit detector.

The feature may improve bit detection and may in particular allow low complexity, low delay and low error rate detection of data bits in the presence of substantial inter-symbol interference. Specifically, the feature may allow an accurate determination of reference levels for e.g. MLSE bit detection based on an automatically adapting and low complexity bit detection in a reference level unit.

According to another aspect of the invention, there is provided a method of detecting bit values, the method comprising: receiving central aperture signal values from an optical disc reader; assigning a first data value to data bits having corresponding central aperture signal values above a first threshold and a second data value to data bits having corresponding central aperture signal values below a second threshold; and assigning data values to at least one data bit of a sequence of data values having corresponding central aperture signal values between the first and second threshold in response to a run length coding of the data bits and a data value of at least one data bit adjacent to the sequence.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of an optical disc reading apparatus in accordance with some embodiments of the invention;

FIG. 2 illustrates an example of a Viterbi detector in accordance with some embodiments of the invention;

FIG. 3 illustrates an example of a Reference Level Unit;

FIG. 4 illustrates an example of a bit detector in accordance with some embodiments of the invention;

FIG. 5 illustrates an example of a central aperture signal for a 30 GByte Blu-ray™ disc;

FIG. 6 illustrates an example of reference level values for a 30 GByte Blu-ray™ disc;

FIG. 7 illustrates an example of a central aperture signal for a 30 GByte Blu-ray™ disc; and

FIG. 8 illustrates an example of reference level values for a 30 GByte Blu-ray™ disc.

### DETAILED DESCRIPTION OF SOME EMBODIMENTS OF THE INVENTION

The following description focuses on embodiments of the invention applicable to an optical disc reading system using a run length limited coding scheme with a fixed minimum run length of two data bits. However, it will be appreciated that the invention is not limited to this application but may be applied to many other systems including for example optical disc reading systems with longer or variable minimum run lengths.

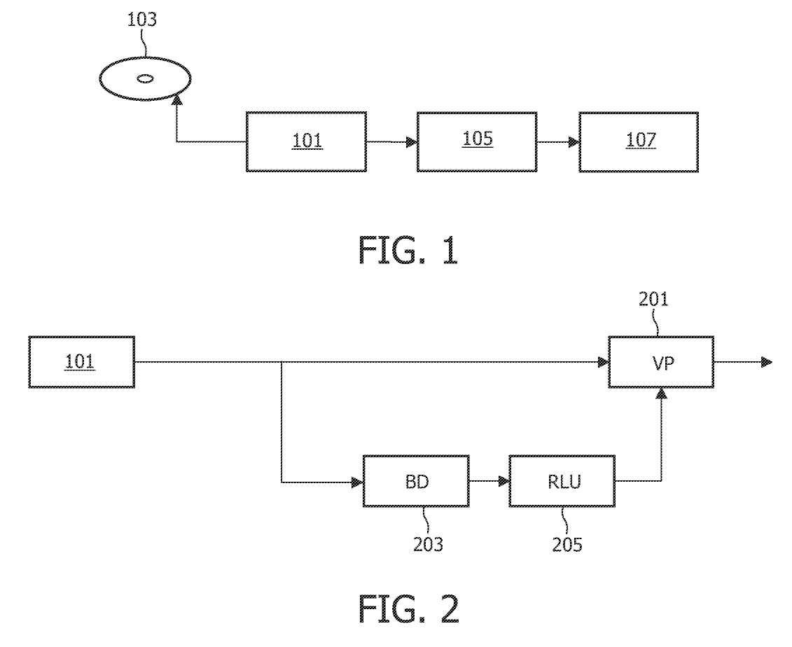

FIG. 1 illustrates an example of an optical disc reading apparatus in accordance with some embodiments of the invention.

In the example, an optical disc data reader 101 reads data from an optical disc 103. The data stored on the optical disc 103 is RLL (Run Length Limited) coded. The data samples read from the optical disc are fed from the optical disc data reader 101 to a Maximum Likelihood Sequence Estimator which specifically is a Viterbi bit detector 105. The Viterbi bit detector 105 uses at the Viterbi algorithm to determine the data values which are read from the optical disc 103. The detected data is fed to a data interface 107 which interfaces to external equipment. For example the data interface 107 may provide an interface to a personal computer.

FIG. 2 illustrates the Viterbi detector 105 in more detail. The data received from the optical disc data reader 101 is fed to a Viterbi processor 201 which performs the MLSE bit detection operation as is well known to the person skilled in the art.

However, in order to determine suitable metrics for the MLSE detection, the Viterbi processor 201 must have information of expected signal values for given data combinations. In the example, this information is generated as reference levels by a reference level unit (RLU) 205 coupled to the Viterbi processor 201.

An RLU provides an automatic and implicit adaptation of a channel model to the measured system by determining an average value for all possible data combinations of a given length. Reference levels can be seen as the average value of the signal for a given modulation bit sequence.

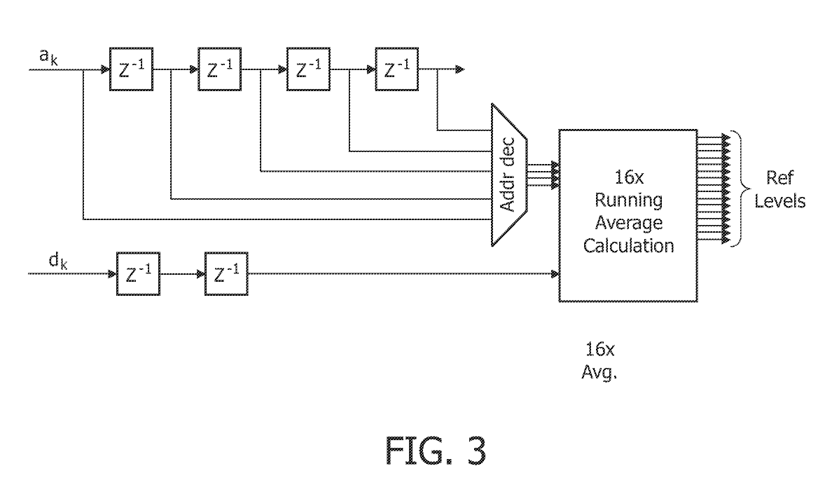

An example of a possible implementation of a five-tap (considering five symbol value combinations) RLU is shown in FIG. 3. The (preliminary) detected modulation bits aₖ are entering together with the synchronised received signal dₖ. For each clock-cycle, 5 modulation bits are transformed into a 4 bit address, pointing to one of the 16 reference levels. Next this reference value is then updated by the value of the received dₖ. e.g. according to:

RLᵢ(k)=(1−α)×RLᵢ(k−1)+α×d(k)

where α is a suitable filter coefficient which is typically very small (e.g. around 0.01).

It will be appreciated that in this example, only 16 reference levels are considered for combinations of 5 data bits. However, due to the Run Length Limitation typically used on optical reading systems, the number of valid data combinations will be lower than the number of possible data combinations.

Thus, the RLU generates a low pass filtered or average signal value for different data bit combinations. For example, for an input sequence of 11111, the RLU maintains a reference value which corresponds to the average signal value that has previously been measured for this bit combination. Thus, the RLU inherently implements a channel model which indicates the expected signal value output from the channel for a given bit combination. This value is automatically generated and maintained as the low pass filtered value previously obtained. The reference level can thus be used by the Viterbi processor 201 to determine the path metrics.

However, the operation of the RLU 205 is based on explicit knowledge or assumptions of the correct data values and accordingly the RLU 205 is coupled to a bit detector 203 which generates preliminary data bits based on the received signal. Simple threshold detection is typically used in many conventional optical readers. However, this results in high error rates which may be unsuitable for many applications. Specifically, for high capacity discs such as 30 GB Blu-ray™ discs, the inter-symbol interference is so high that simple threshold detection is not accurate and specifically the inter-symbol interference is generally so high that the decision point aperture (or eye) closes completely for some data combinations.

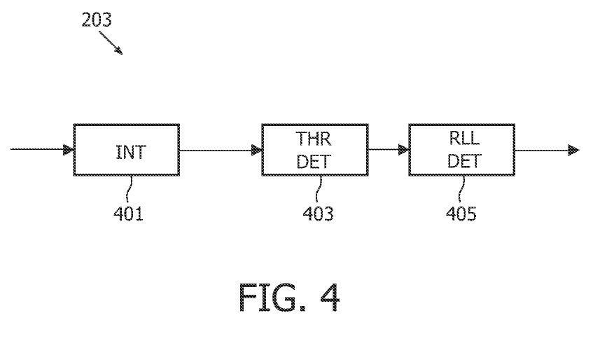

FIG. 4 illustrates a bit detector in accordance with some embodiments of the invention. The bit detector may specifically be the bit detector 203 of FIG. 2 and will be described with reference thereto.

In contrast to a conventional threshold or slicer detector, the bit detector 203 of FIG. 4 does not use a single but rather two thresholds which divide the decision intervals into a high reliability first data value interval, a high reliability second data value interval and an uncertain data interval. The data bits having corresponding central aperture signal values falling in the high reliability intervals are assigned the corresponding data value. These data values are then used together with knowledge of the run length coding and the corresponding signal values to determine data values for the data bits falling in the uncertain region.

Specifically, the bit detector 203 comprises an interface 401 which receives central aperture signal values from the optical disc data reader 101. In the example, the central aperture signal values correspond to the HF signal value samples at the decision instant for the data bits. Ideally, this time instant is identical to the time of the maximum signal value for the given data bit when noise and inter-symbol interference contributions are removed. In other words, the central aperture signal value corresponds to the maximum opening of the aperture or eye for the HF signal. It will be appreciated that due to noise and synchronisation inaccuracies, the exact timing may deviate from the optimal.

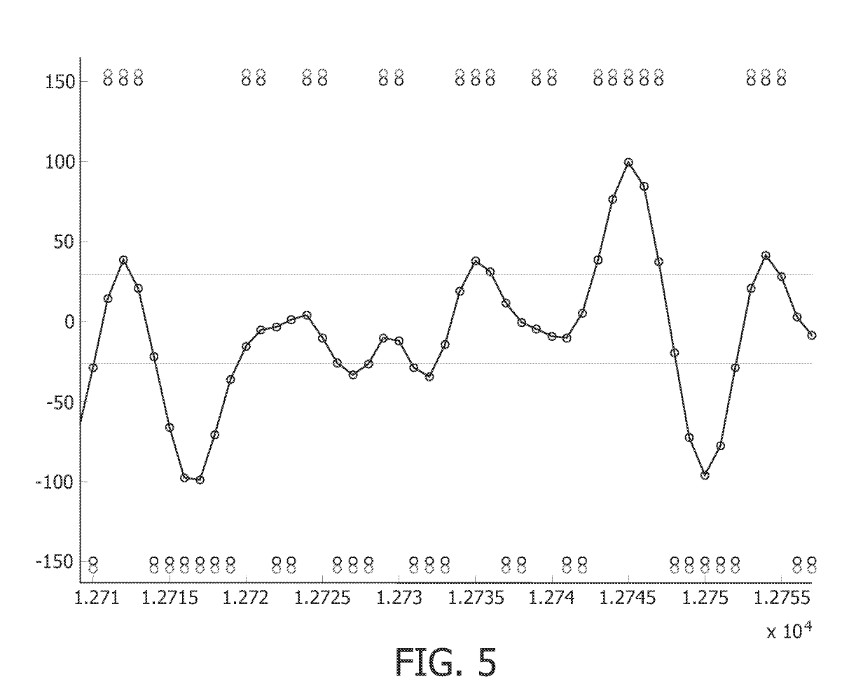

FIG. 5 illustrates an example of an HF signal from a 30 GByte Blu-ray™ disc. Specifically, the figure shows the digital central aperture signal at 30 GB density after timing recovery and equalization. The central aperture signal values are in the example illustrated by “o” and the correct data values are indicated by “8”. However, as can be seen, using a simple conventional threshold detector with a decision threshold of “0” does not result in correct bit decisions even in the absence of noise or timing inaccuracies. For example, due to inter-symbol interference sample number 11 is below the zero threshold despite the correct data value being a +1.

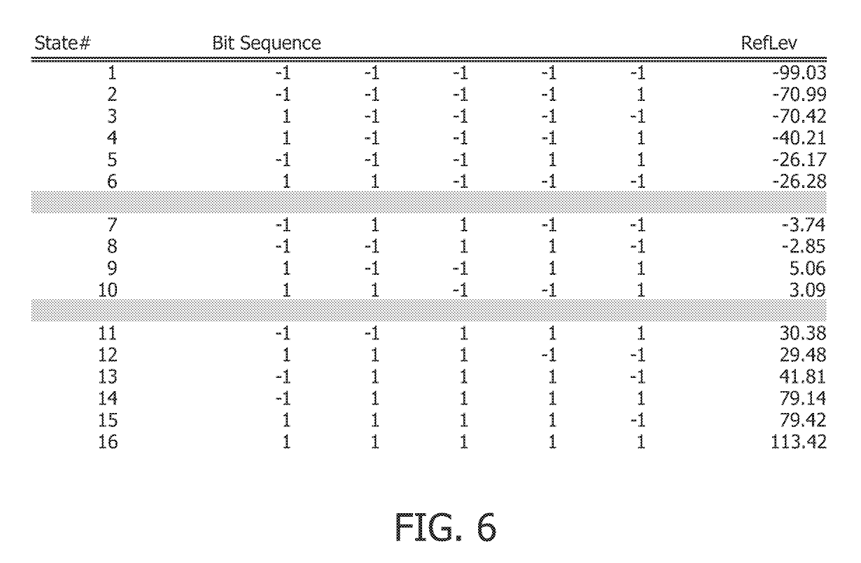

FIG. 6 illustrates an example of the central aperture reference levels that correspond to the various combinations of a five data bits for a signal from a 30 GByte Blu-ray™ disc. The data values reflect the reference levels using known data bits, with correct synchronisation and without noise. As can be seen, there are several states that all have an average value around 0 and furthermore there is no single threshold that can be used to determine if the central data bit is a 1 or −1.

In the bit detector 203 of FIG. 2, the received central aperture signal values are fed to a threshold detector 403 which applies two thresholds rather than a single threshold. Specifically, the threshold detector 403 assigns a first data value to data bits having a central aperture signal values above a first threshold and a second data value to data bits having a central aperture signal values below a second threshold.

The first and second thresholds are in the example selected such that the data values are assigned with a high reliability. Thus, if the central aperture signal value is above or below the corresponding threshold such that a data value is assigned to the data bit then this data value is almost certainly correct. The thresholds may thus be selected to ensure that when a data value is assigned by the threshold detector 403, the probability of this being in error is below a given threshold. The exact value of this threshold may depend on the specific embodiment but can for example be 10⁻³ or 10⁻⁴.

In the specific example of the 30 GByte Blu-ray™ disc of FIG. 6, the threshold detector implements slicing levels related to states 5/6 (around −26) and states 11/12

(around +29). Thus, for signal values below −26 a −1 is assigned to the data bit and for signal values above +29 a +1 is assigned to the data bit. These data value assignments are highly reliable and the decision error will typically be insignificant.

Furthermore, the threshold detector 403 does not assign an explicit binary data value to data bits having central aperture signal values between the two thresholds. Rather these data bits are indicated as unreliable or uncertain data bits, for example by assigning a zero data value to them.

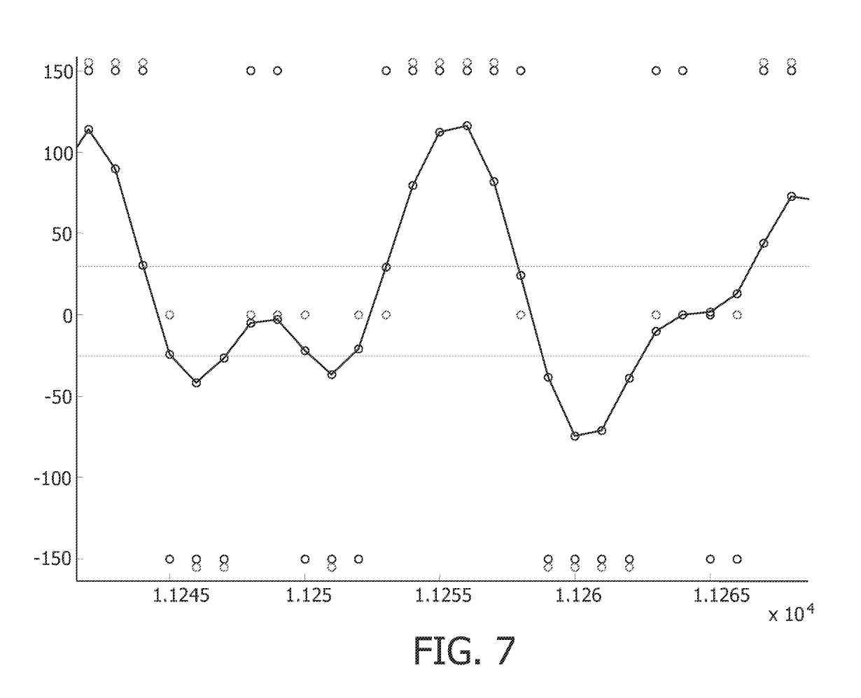

FIG. 7 illustrates an example of the data values assigned by the threshold detector 403 for a signal from a 30 GByte Blu-ray™ disc.

Furthermore, the two thresholds which are used by the threshold detector are selected such that a run length higher than a minimum run length of the run length code does not correspond to a central aperture signal value between the two thresholds. Thus, only minimum run length sequences will have inter-symbol interference that results in central aperture signal values between the two thresholds.

In the example of FIG. 6, it can clearly be seen that the thresholds are selected such that the four states having central aperture signal values between the thresholds do not correspond to any data sequences which have run lengths longer than the minimum run length of two.

Thus, the output of the threshold detector 403 corresponds to a data signal having a number of highly reliable data values as well as one or more uncertain sequences known not to have any run lengths higher than the minimum run length. This information is fed from the threshold detector 403 to a RLL detector 405 which uses the information to assign data values to the data of the uncertain sequence(s).

Thus, the RLL detector 405 assigns data values to at least one data bit of an unknown sequence of data bits with central aperture signal values between the first and second threshold in response to a run length coding of the data bits and a data value of at least one data bit adjacent to the sequence.

Specifically, as it is known that the data bits of the uncertain sequence corresponds to sequences of minimum run length, the RLL detector 405 divides the uncertain sequence into a number of subsets with a size corresponding to the minimum run length and a remainder subset. The remainder subset corresponds to the number of data bits which is left over after an integer number of minimum run length subset has been determined.

For the specific example of a minimum run length of two, the sequence is divided into data bit pairs with a remainder subset either being empty (if the number of data bits of the sequence is even) or comprising a single data bit (if the number of data bits of the sequence is odd).

Each of the subsets corresponds to a minimum run length set and adjacent subsets must necessarily have the opposite polarity in order to ensure that the run lengths are kept at the minimum run length. Thus, the RLL detector 405 proceeds to assign data values to the subsets and to allocate these to the sequence such that the minimum run length criterion is maintained.

Specifically, if the remainder subset is not empty, in the specific example corresponding to the sequence comprising an odd number of data bits, the sequence must necessarily comprise a train of alternating polarity subsets (corresponding to a number of 12 sequences) either preceded or followed by the remainder subset.

In the specific example, central aperture signal values between the two thresholds can only be achieved by a train of alternating pairs of data bits with either a single bit at the start of the sequence or at the end of the sequence. The single data bit will be part of a run length sequence starting before the sequence or ending after the sequence and will thus have the same data value as the adjacent bit outside the sequence.

Accordingly, the RLL detector 405 determines if the remainder subset should be located at the beginning or the end of the sequence. If the remainder subset (the single bit) is at the beginning at the sequence, the data value is set equal to the data bit immediately preceding the sequence. If the remainder subset (the single bit) is at the end at the sequence, the data value is set equal to the data bit immediately following the sequence.

It will appreciated that different criteria may be used for determining the location of the remainder subset. For example, the resulting sequence of each possibility may be determined and the corresponding central aperture signal values can be compared to the actual central aperture signal values received to select the possibility most closely resembling this.

In the specific example, the RLL detector 405 determines a distance between the central aperture signal values of the first bit of the sequence and the threshold closest to the central aperture signal value of the data bit immediately before the sequence. Similarly, the RLL detector 405 determines a distance between the central aperture signal values of the last bit of the sequence and the threshold closest to the central aperture signal value of the data bit immediately after the sequence. The remainder subset is then placed at the location for which the distance is the lowest as this is the most likely location for the single bit.

Thus, if the distance between the first data bit and the threshold of the preceding data bit is the lowest, the RLL detector 405 sets the value of the remainder data set equal to the data value of the preceding data bit and places this at the beginning of the sequence. It then proceeds to fill the sequence up with minimum run length subsets by inverting the data value between the subsets.

Similarly, if the distance between the last data bit and the threshold of the following data bit is the lowest, the RLL detector 405 locates a full subset at the beginning of the sequence and sets the data value as the opposite of that of the preceding data bit. It then proceeds to fill the sequence up with minimum run length subsets by inverting the data value between each subset. When no more full subsets can be inserted, the remainder subset is inserted with a data value inverted with respect to the previous subset and equal to that of the data bit following the sequence.

If the number of data bits in the sequence is equal to an integer multiple of minimum run length data sequences, the remainder subset is empty. In this case, an exact number of minimum run length subsets can be inserted. However, it is not certain if the start of the sequence aligns with the beginning of a new run length sequence.

However, this is determined to be the case if:

the number of subsets in the sequence is even and the data value of the data bit immediately preceding the data bit is different than the data bit immediately following the data sequence OR

the number of subsets in the sequence is odd and the data value of the data bit immediately preceding the data bit is the same as the data bit immediately following the data sequence.

In this case, the sequence is made up of minimum run length sequences starting at the beginning of the sequence and accordingly the RLL detector 405 inserts a train of subsets with the data value of the first subset being the opposite of the data value of the data bit immediately preceding the sequence.

If the conditions are not met, i.e. if:

the number of subsets in the sequence is even and the data value of the data bit immediately preceding the data bit is the same as the data bit immediately following the data sequence OR

the number of subsets in the sequence is odd and the data value of the data bit immediately preceding the data bit is different than the data bit immediately following the data sequence;

the data sequence begins with part of a run length sequence started outside the sequence and ends with part of a run length sequence ending outside the sequence. In the specific case of a minimum run length of two, the uncertain sequence thus starts with a single data bit which is part of the run length sequence starting outside the uncertain sequence and ends with a single data bit which is part of the run length sequence ending outside the uncertain sequence.

Accordingly, the RLL detector 405 divides one of the subsets into an initial subset located at a beginning of the sequence and a final subset at the end of the sequence. The data value of the initial subset is set equal to the data value of the data bit immediately preceding the sequence and the data value of the final subset is set equal to the data value of the data bit immediately following the sequence.

Thus, by exploiting the restrictions imposed by the decision thresholds and the run length coding, the RLL detector 405 determines the data values for the uncertain sequence. It will be appreciated that the described approach may be applied to an uncertain sequence of any length (including a single data bit) and may be applied to any number of uncertain sequences.

As a specific example, for a minimum run length of two, the RLL detector 405 may apply the following specific algorithm:

Odd number of unknown bits:

Determine a distance between the first uncertain data central aperture signal value and the value of the threshold used for immediately preceding data bit

Determine a distance between the last uncertain data central aperture signal value and the value of the threshold used for the immediately following data bit

IF (first distance<last distance)

Add one more bit equal to preceding bit, flip polarity and add extra I2 trains to fill unknown bits

### ELSE

Directly flip polarity relative to left known bit, add Extra I2 trains to fill unknown bits and complete by inserting a single data bit

### END

Even number of unknown bits:

Check if sequence is neutral (i.e. if an even amount of I2's fit in)
Check if preceding (known) bit and following (known) bit have the same data value.

IF both questions have the same answer

Add one more bit equal to preceding (known) bit, flip polarity and add extra I2 trains to fill unknown bits and last unknown bit is equal to the following (known) bit

### ELSE

Directly flip polarity relative to preceding (known) bit, and add extra I2 trains to fill unknown bits

### END

Experiments have shown that such an approach can lead to a bit error rate of 4·10⁻⁴ (or even 8·10⁻⁵ with some optimisation of the applied thresholds). In contrast, a single threshold detector provides a bit error rate of around 0.1. Thus, a much improved performance can be achieved by the bit detector and thus by the optical disc reading system as a whole.

The detected data bits are fed to the RLU 205 which proceeds to determine the reference levels used by the Viterbi processor 201.

Furthermore, the RLU 205 may in some embodiments comprise means for determining the first and/or the second threshold which is used by the threshold detector 403. For example, for the example of the 30 GByte Blu-ray™ disc of FIG. 6, the RLU 205 may determine the reference levels of all the states and may determine the upper threshold used by the threshold detector 403 as a value, say, 10% below the reference level determined for state 11. The same approach may be used for the lower threshold.

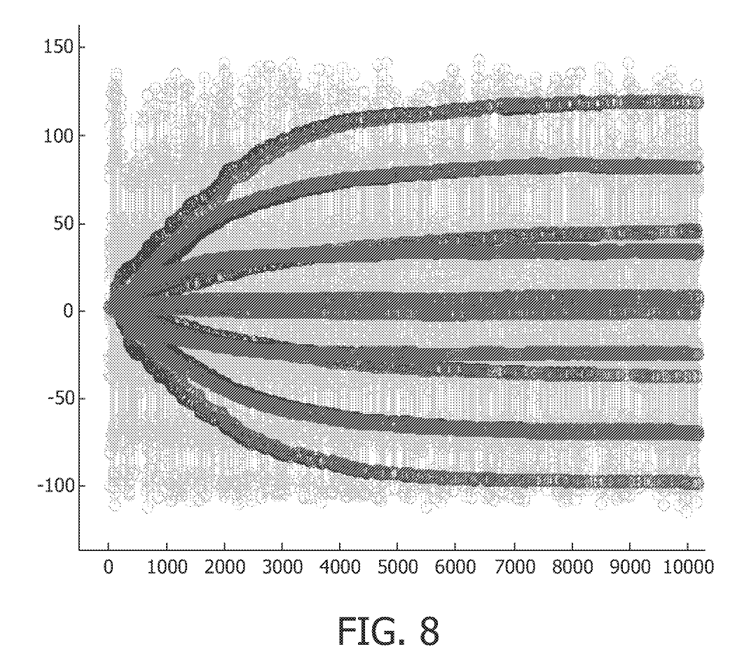

As the reference levels are determined based on the detected bits a closed-loop system is formed by the threshold detector 403 and the RLU 205. However, experiments have shown that even without any prior knowledge of the reference levels, a stable, reliable and fast initialisation is possible. FIG. 8 illustrates an example of how the reference levels quickly attain their correct values starting from an initial state of zero.

It will be appreciated that although the above description has focussed on a fixed minimum run length, the minimum run length may in some embodiments be variable and dynamic and may specifically be described by a function or algorithm. For example, the minimum run length may be of length N for a number of iterations but change to M after a certain number of repetitions of run lengths of length N.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of claims in any way.

1. A bit detector (203) for an optical disc reading apparatus, the bit detector (203) comprising:
means (401) for receiving central aperture signal values from an optical disc reader (101);
first means (403) for assigning a first data value to data bits having corresponding central aperture signal values above a first threshold and a second data value to data bits having corresponding central aperture signal values below a second threshold;
second means (405) for assigning data values to at least one data bit of a sequence of data bits having corresponding central aperture signal values between the first and second threshold in response to a run length coding of the data bits and a data value of at least one data bit adjacent to the sequence.

2. The bit detector (203) of claim 1 wherein the second means (405) is arranged to divide the sequence into a number of subsets of a minimum run length and a remainder subset comprising a number of remaining data bits, the data bits in each subset being assigned the same data value and consecutive subsets in the sequence being assigned opposite data values.

3. The bit detector (203) of claim 2 wherein the second means (405) is arranged to
determine a first distance indication from a first central aperture signal value of an earliest data bit of the sequence to a threshold of the first and second threshold closest to a central aperture signal value of a preceding data bit preceding the earliest data bit;
determine a second distance indication from a second central aperture signal value of a latest data bit of the sequence to a threshold of the first and second threshold closest to a central aperture signal value of a data bit following the latest data bit; and
determining a location of the remainder subset at the beginning or end of the sequence in response to a comparison of the first and second distance indication.

4. The bit detector (203) of claim 3 wherein the second means (405) is arranged to assign a data value to the remainder subset corresponding to a data value assigned to an adjacent data bit outside the sequence.

5. The bit detector (203) of claim 2 wherein the second means (405) is arranged to set a data value of an initial subset of the sequence to an opposite data value of a prior data value of a data bit immediately preceding the sequence if:
the remainder subset is empty;
the prior data value is different than a data value of a data bit immediately following the sequence; and
a number of subsets in the sequence is even.

6. The bit detector (203) of claim 2 wherein the second means (405) is arranged to set a data value of an initial subset of the sequence to an opposite data value of a prior data value of a data bit immediately preceding the sequence if:
the remainder subset is empty;
the prior data value is identical to a data value of a data bit immediately following the sequence; and
a number of subsets in the sequence is odd.

7. The bit detector (203) of claim 2 wherein the second means (405) is arranged to divide a subset into an initial subset located at a beginning of the sequence and a final subset at the end of the sequence and to assign a same data value to the initial subset as a prior data value of a data bit immediately preceding the sequence and a same data value to the final subset as a following data value of a data bit immediately following the sequence if:
the remainder subset is empty;
the prior data value is different than a data value of a data bit immediately following the sequence; and
a number of subsets in the sequence is odd.

8. The bit detector (203) of claim 2 wherein the second means (405) is arranged to divide a subset into an initial subset located at a beginning of the sequence and a final subset at the end of the sequence and to assign a same data value to the initial subset as a prior data value of a data bit immediately preceding the sequence and a same data value to the final subset as a following data value of a data bit immediately following the sequence if:
the remainder subset is empty;
the prior data value is identical to a data value of a data bit immediately following the sequence; and
a number of subsets in the sequence is even.

9. The bit detector (203) of claim 1 wherein the first threshold and the second threshold are such that a probability of assigning an incorrect data value is below a threshold.

10. The bit detector (203) of claim 1 wherein the first threshold and the second threshold are such that a run length higher than a minimum run length of the run length code does not correspond to a central aperture signal value between the second and first thresholds.

11. An optical disc reading apparatus comprising:
a disc reader (101) for generating a first signal by reading an optical disc (103); and
a bit detector (203) for an optical disc reading apparatus, the bit detector (203) comprising
means (401) for receiving central aperture signal values from the disc reader (101);
first means (403) for assigning a first data value to data bits having corresponding central aperture signal values above a first threshold and a second data value to data bits having corresponding central aperture signal values below a second threshold;
second means (405) for assigning data values to at least one data bit of a sequence of data values having corresponding central aperture signal values between the first and second threshold in response to a run length coding of the data bits and a data value of at least one data bit adjacent to the sequence.

12. The optical disc reading apparatus of claim 11 further comprising:
a reference level unit (405) arranged to determine the first threshold in response to bit detections by the bit detector (203).

13. A method of detecting bit values, the method comprising:
receiving central aperture signal values from an optical disc reader;
assigning a first data value to data bits having corresponding central aperture signal values above a first threshold and a second data value to data bits having corresponding central aperture signal values below a second threshold; and
assigning data values to at least one data bit of a sequence of data values having corresponding central aperture signal values between the first and second threshold in response to a run length coding of the data bits and a data value of at least one data bit adjacent to the sequence.
